(19) United States
(12) Patent Application Publication
(10) Pub. No.: US 2015/0198058 A1
(43) Pub. Date: Jul. 16, 2015

(54) STEAM TURBOMACHINE VALVE HAVING A FLOATING SEAL ASSEMBLY

(71) Applicant: General Electric Company, Schenectady, NY (US)

(72) Inventor: Abhishek Chowdhury, Bangalore (IN)

(73) Assignee: General Electric Company, Schenectady, NY (US)

(21) Appl. No.: 14/156,888

(22) Filed: Jan. 16, 2014

(51) Int. Cl. F01D 17/14; F01K 7/22

(52) U.S. Cl. CPC F01D 17/145; F01K 7/226; F05D 2300/175; F05D 2300/177; F05D 2300/171

(57) ABSTRACT

A steam turbomachine valve includes a valve body having an inlet portion, an outlet portion, and an interior portion. The interior portion includes an inner wall. A valve member is moveably disposed within the interior portion of the valve body. The valve member includes an outer surface that is spaced from the inner wall by a gap. A floating seal is mounted to the inner wall. The floating seal spans the gap and contacts the outer surface of the valve member.

### BACKGROUND OF THE INVENTION

The subject matter disclosed herein relates to the art of steam turbomachines and, more particularly, to a steam turbomachine valve having a floating seal assembly.

Steam turbomachine systems generally include multiple turbine sections each of which extracts work from a flow of steam. The multiple turbine sections may include a high pressure (HP) steam turbine portion, an intermediate pressure (IP) steam turbine portion, and a low pressure (LP) steam turbine portion. One or more valves control the flow of steam passing from one of the turbine sections to others of the turbine sections and, in some cases, to a heat recovery steam generator (HRSG). Each of the one or more valves includes a valve body that supports a valve member. The position of the valve member is selectively controlled to block passage of the steam flow or allow the steam flow to pass. The valve may include a seal between the valve member and an inner wall of the valve body. The seal prevents steam leakage through a gap that exists between the valve member and the valve body.

### BRIEF DESCRIPTION OF THE INVENTION

According to one aspect of an exemplary embodiment, a steam turbomachine valve includes a valve body having an inlet portion, an outlet portion, and an interior portion. The interior portion includes an inner wall. A valve member is moveably disposed within the interior portion of the valve body. The valve member includes an outer surface that is spaced from the inner wall by a gap. A floating seal is mounted to the inner wall. The floating seal spans the gap and contacts the outer surface of the valve member.

According to another aspect of an exemplary embodiment, a steam turbomachine includes a high pressure (HP) turbine portion, an intermediate pressure (IP) turbine portion operatively connected to the HP turbine portion, a low pressure (LP) turbine portion operatively connected to at least one of the HP turbine portion and the IP turbine portion, and a steam valve fluidically connected to at least one of the HP turbine portion, IP turbine portion, and LP turbine portion. The steam valve includes a valve body having an inlet portion fluidically connected to the one of the HP turbine portion, IP turbine portion, and LP turbine portion, an outlet portion, and an interior portion. The interior portion includes an inner wall. A valve member is moveably disposed within the interior portion of the valve body. The valve member includes an outer surface that is spaced from the inner wall by a gap. A floating seal is mounted to the inner wall. The floating seal spans the gap and contacts the outer surface of the valve member.

According to yet another aspect of an exemplary embodiment, a steam turbomachine system includes a high pressure (HP) turbine portion, an intermediate pressure (IP) turbine portion operatively connected to the HP turbine portion, a low pressure (LP) turbine portion operatively connected to at least one of the HP turbine portion and the IP turbine portion, and one of a heat recovery steam generator (HRSG) and a boiler operatively connected to each of the HP turbine portion, IP turbine portion, and LP turbine portion, and a steam valve fluidically connected to at least one of the HP turbine portion, IP turbine portion, and LP turbine portion. The steam valve includes a valve body having an inlet portion fluidically connected to the one of the HRSG and the boiler, an outlet portion fluidically connected to the one of the HP turbine portion, IP turbine portion, and LP turbine portion, and an interior portion. The interior portion includes an inner wall. A valve member is moveably disposed within the interior portion of the valve body. The valve member includes an outer surface that is spaced from the inner wall by a gap. A floating seal is mounted to the inner wall. The floating seal spans the gap and contacts the outer surface of the valve member.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic view of a steam turbomachine system including a steam turbomachine fluidically connected to a valve having a floating seal assembly, in accordance with an exemplary embodiment;

FIG. 2 is a partially cut-away perspective view of the valve having the floating seal assembly of FIG. 1; and

FIG. 3 is a plan view of the floating seal assembly of FIG. 2.

The detailed description explains embodiments of the invention, together with advantages and features, by way of example with reference to the drawings.

### DETAILED DESCRIPTION OF THE INVENTION

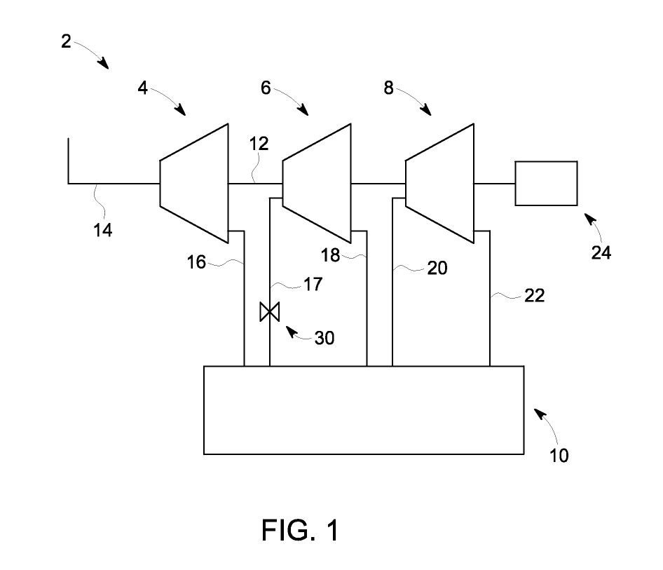

A steam turbomachine system, in accordance with an exemplary embodiment, is indicated generally at 2, in FIG. 1. Steam turbomachine system 2 includes a high pressure (HP) turbine portion 4 operatively connected to an intermediate pressure (IP) turbine portion 6 and a low pressure (LP) turbine portion 8. HP turbine portion 4, IP turbine portion 6 and LP turbine portion 8 are fluidically connected to a heat recovery steam generator (HRSG) 10. Alternatively, steam turbomachine system 2 may be connected to a boiler. At this point it should be understood that while shown as being mechanically linked by a shaft 12, HP turbine portion 4, IP turbine portion 6 and LP turbine portion 8 may also be separate mechanisms. The term “operatively connected” should be understood to include a mechanical and/or a fluidic connection.

HP turbine portion 4 receives steam through a HP inlet 14 and passes steam to a HP portion (not separately labeled) of HRSG 10 through a HP outlet 16. IP turbine portion 6 is fluidically connected to an IP portion (also not separately labeled) of HRSG 10 through an IP inlet 17 and an IP outlet 18. LP turbine portion 8 is fluidically connected to a LP portion (not separately labeled) of HRSG 10 through a LP inlet 20 and a LP outlet 22. LP turbine portion 8 is also shown mechanically linked to a mechanical load 24 such as a generator, a pump or the like.

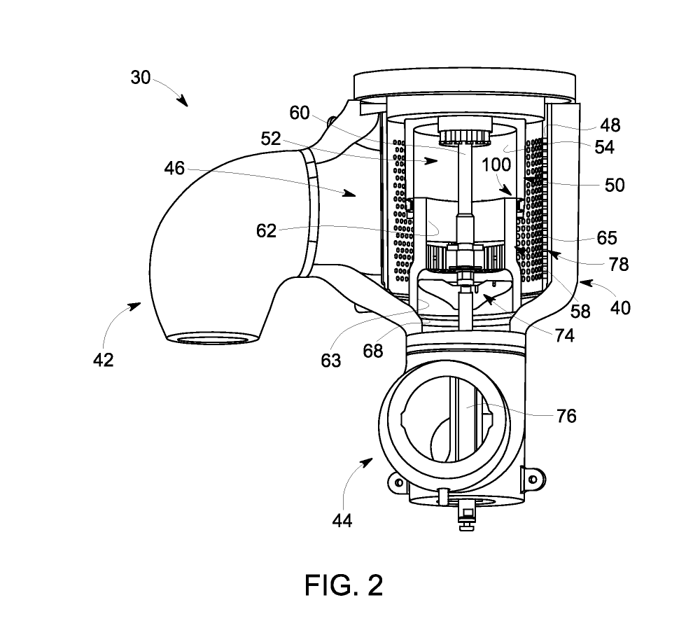

In accordance with an exemplary embodiment, a steam valve 30 is fluidically connected to IP inlet 17. Of course, it should be understood that additional valves (not shown) may be connected between steam turbomachine system 2 and HRSG 10. Also, a valve may be provided on HP inlet 14. As shown in FIG. 2, steam valve 30 includes a valve body 40 including an inlet portion 42 fluidically connected to HRSG 106 and an outlet portion 44 fluidically connected to IP turbine portion 6. Valve body 40 also includes a first interior portion 46 having a first inner wall 48 that surrounds a balance chamber 50. Balance chamber 50 is formed from a high alloy stainless steel including a chromium content of between about 10% and 16% such as Type 410 Stainless Steel, Type 416 Stainless Steel, Cost E, Cost B and/or 12 chrome. Balance chamber 50 includes a second interior portion 52 having a second inner wall 54.

A first valve member 58 is moveably arranged within balance chamber 50. First valve member 58 may take the form of a control valve disk or an intercept valve disk and is operatively connected to a first valve stem 60. First valve stem 60 is connected to an actuator (not shown) which may be arranged on an upper portion (not separately labeled) of steam valve 30. The actuator controls the opening and closing of the first valve member 58 through the first valve stem 60 to control an amount of steam flow through steam valve 30.

First valve member 58 includes a first inner surface section 62, an opposing, second inner surface section 63 and an outer surface 65. First valve member 58 is formed from a nickel-chromium based superalloy such as Inoco® and is shiftable between a first or closed position and a second or open position. In the closed position, first valve member 58 rests upon a valve seat 68 formed in first interior portion 46 at inlet portion 42. In the open position, steam may freely flow from inlet portion 42 to outlet portion 44.

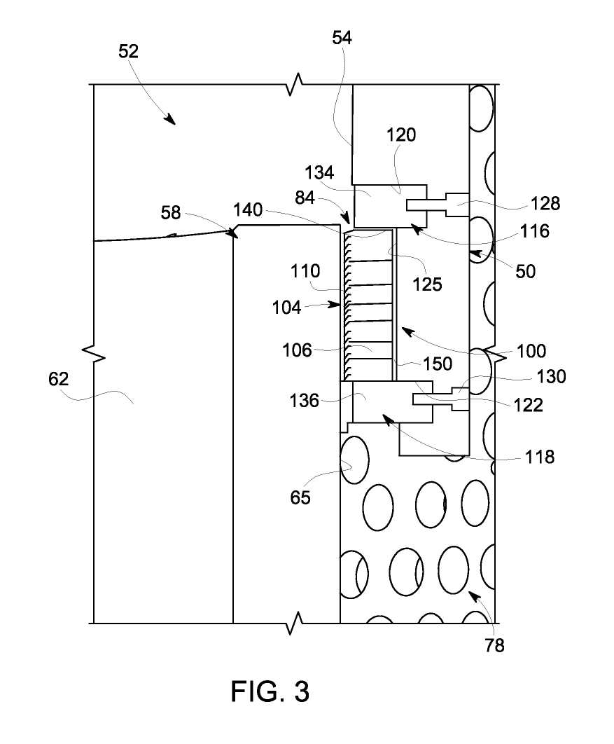

A second valve member 74, shown in the form of a stop valve, is arranged within an area (not separately labeled) bounded by second inner surface section 63 at valve seat 68. Second valve member 74 is operatively connected to a second valve stem 76 and is selectively closed to stop all steam flow through steam valve 30 in the event first valve member 58 fails to operate. Steam valve 30 is also shown to include a strainer 78 disposed about balance chamber 50. Steam inside balance chamber 50 is selectively evacuated to achieve a lower pressure differential between upstream valve member 58 and 74 and downstream outlet portion 44. The evacuation of steam enables first and second valve members 58 and 74 to be shifted to the open position with lower hydraulic actuator forces on respective ones of first and second valve stems 60 and 76. To further facilitate opening and closing of steam valve 30, a clearance or gap 84 (FIG. 3) exists between outer surface 65 of first valve member 58 and second inner wall 54.

Gap 84 is sized to facilitate operation of first valve member 58 while at the same time limiting steam leakage that might replace the evacuated steam. It is desirable to maintain gap 84 at a predetermined dimension over an operational life of steam valve 30. Accordingly, it is desirable, as will be detailed below, to limit oxidation growth on interfacing components to ensure an uncompromised operation of steam valve 30.

In further accordance with an exemplary embodiment illustrated in FIG. 3, steam valve 30 includes a seal assembly 100 that spans gap 84 to limit steam leakage from inlet portion 42 to outlet portion 44. At this point it should be understood that the term “spans” indicates that seal assembly 100 extends across gap 84 and may or may not be in contact with outer surface 65 of first valve component 58. Seal assembly 100 includes a “floating seal” 104 supported by second inner wall 54. Floating seal 104 is formed from either a singular or a plurality of annular seal members, one of which is indicated at 106. Each annular seal member 106 is formed from a nickel-chromium based superalloy such as Inco® Nickel-chromium based super alloys exhibit extremely low oxide growth rates when exposed to high temperature operating conditions as compared with high alloy steel. At this point it should be understood that while described as being annular, each seal member 106 may have a split to ease installation into second inner wall 54. Alternatively, each seal member 106 may be formed from one or more seal sections. Further, each seal member 106 includes a plurality of corrugations 110 that provide an interface with outer surface 65 of first valve member 58. The corrugations provide aerodynamic obstructions that function to reduce leakage of steam to balance chamber 50.

In the exemplary embodiment shown, seal members 106 are arranged between a first seal support 116 and a second seal support 118. First seal support 116 is constrained within a first recess 120 formed in second inner wall 54. Likewise, second seal support 118 is constrained within a second recess 122 formed in second inner wall 54. Seal members 106 are arranged within a third recess 125 arranged between first and second recesses 120 and 122. Constraining first and second seal supports 116 and 118 within recesses 120 and 122 reduces clearance problems associated with oxidation growth. That is, recesses 120 and 122 constrain seal support displacement that might otherwise occur as a result of oxidation growth. More specifically, by locating first and second seal supports 116 and 118 within recesses 120 and 122, oxidation growth, which may occur on surfaces formed from 12 Chrome during operation, would have little effect on clearances between first and second seal supports 116 and 118 and seal members 106. In this manner, gap 84 is maintained at a desired dimension to, facilitate the “floating” nature of seal members 106 which is further described below.

First seal support 116 is secured to second inner wall 54 by a first plurality of mechanical fasteners 128. Similarly, second seal support 118 is secured to second inner wall 54 by a second plurality of mechanical fasteners 130. First and second seal supports 116 and 118 take the form of first and second split rings 134 and 136. A gap 140 exists between first split ring 134 and seal members 106. Gap 140 accommodates thermal and/or oxidation growth effects to enable seal assembly 100 to “float” or move within recess 125. In accordance with an aspect of the exemplary embodiment, first and second split rings 134 and 136 are formed from nickel-chromium based superalloy such as Inoco®. The use of nickel-chromium based superalloys enables seal assembly 100 to accommodate differential thermal expansions of balance chamber 50 and first valve member 58, while maintaining a radial clearance between seal assembly 100 and first valve member 58 through the operating cycle. Further, by mounting seal assembly 100 on second inner wall 54, balance chamber 50 may be formed by a material other than a nickel-chromium superalloy, such as a high alloy stainless steel including a chromium content of between about 10% and 16% such as Type 410 stainless Steel, Type 416 Stainless steel, Cost E, Cost B and/or 12 chrome. Forming balance chamber 50 from a material other than the nickel-based superalloy will greatly reduce production and maintenance costs of steam valve 30. Further, the use of the nickel-chromium based superalloy to form first valve member 58 and seal assembly 100 enables steam valve 30 to accommodate higher temperature steam flows. Specifically, nickel-chromium based superalloy to nickel-chromium based superalloy contact between seal assembly 100 and first valve member 58 ensures that clearances between outer surface 65 and second inner wall 54 remain substantially stable at all operational temperatures and pressures and further enables steam valve 30 to accommodate steam temperatures of 1150° F. (621.1° C.) or more.

First valve member 58, which is formed from a nickel-chromium based superalloy, expands at a higher rate than the balance chamber 50, which is formed from a high alloy stainless steel. The lower expansion rate of balance chamber 50 constrains the expansion of seal assembly 100, which might otherwise reduce gap 84. In accordance with an aspect of the exemplary embodiment, seal assembly 100 “floats” to account for the difference in rates of thermal expansion between first valve member 58 and balance chamber 50. The “floating” nature of seal assembly 100 maintains gap 84 at a desired dimension during an operational temperature range of steam valve 30. In addition, a gap 150 may exist between seal assembly 100 and balance chamber 50. Gap 150 may accommodate expansions of seal assembly 100.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A steam turbomachine valve comprising:
a valve body including an inlet portion, an outlet portion, and an interior portion, the interior portion including an inner wall;
a valve member moveably disposed within the interior portion of the valve body, the valve member including an outer surface that is spaced from the inner wall by a gap; and
a floating seal mounted to the inner wall, the floating seal spanning the gap and contacting the outer surface of the valve member.

2. The steam turbomachine valve according to claim 1, further comprising: a first seal support mounted to the inner wall and a second seal support mounted to the inner wall spaced from the first seal support, the floating seal being arranged between the first and second seal supports.

3. The steam turbomachine valve according to claim 2, wherein each of the first and second seal supports extends into, and is constrained by, the inner wall.

4. The steam turbomachine valve according to claim 2, wherein the first seal support comprises a first split ring and the second seal support comprises a second split ring.

5. The steam turbomachine valve according to claim 2, wherein each of the first and second seal supports are formed from a nickel-chromium based superalloy.

6. The steam turbomachine valve according to claim 1, wherein the floating seal comprises a plurality of seal members.

7. The steam turbomachine valve according to claim 1, wherein the floating seal is formed from a nickel-chromium based superalloy.

8. The steam turbomachine valve according to claim 7, wherein the valve member is formed from a nickel-chromium based superalloy.

9. The steam turbomachine valve according to claim 1, wherein the inner wall defines a balance chamber formed from a high alloy stainless steel including a chromium content of between about 10% and 16%.

10. A steam turbomachine comprising:
a high pressure (HP) turbine portion;
an intermediate pressure (IP) turbine portion operatively connected to the HP turbine portion;
a low pressure (LP) turbine portion operatively connected to at least one of the HP turbine portion and the IP turbine portion; and
a steam valve fluidically connected to at least one of the HP turbine portion, IP turbine portion, and LP turbine portion, the steam valve comprising:
a valve body including an inlet portion fluidically connected to the one of the HP turbine portion, IP turbine portion, and LP turbine portion, an outlet portion, and an interior portion, the interior portion including an inner wall;
a valve member moveably disposed within the interior portion of the valve body, the valve member including an outer surface that is spaced from the inner wall by a gap; and
a floating seal mounted to the inner wall, the floating seal spanning the gap and contacting the outer surface of the valve member.

11. The steam turbomachine according to claim 10, further comprising: a first seal support mounted to the inner wall and a second seal support mounted to the inner wall spaced from the first seal support, the floating seal being arranged between the first and second seal supports.

12. The steam turbomachine according to claim 11, wherein each of the first and second seal supports extends into, and is constrained by, the inner wall.

13. The steam turbomachine according to claim 11, wherein the first seal support comprises a first split ring and the second seal support comprises a second split ring.

14. The steam turbomachine according to claim 11, wherein each of the first and second seal supports are formed from a nickel-chromium based superalloy.

15. The steam turbomachine according to claim 10, wherein the floating seal comprises a plurality of seal members formed from a nickel-chromium based superalloy.

16. The steam turbomachine according to claim 15, wherein the valve member is formed from a nickel-chromium based superalloy.

17. The steam turbomachine according to claim 10, wherein the inner wall defines a balance chamber formed from a high alloy stainless steel including a chromium content of between about 10% and 16%.

18. A steam turbomachine system comprising:
a high pressure (HP) turbine portion;
an intermediate pressure (IP) turbine portion operatively connected to the HP turbine portion;
a low pressure (LP) turbine portion operatively connected to at least one of the HP turbine portion and the IP turbine portion;
one of a heat recovery steam generator (HRSG) and a boiler operatively connected to each of the HP turbine portion, IP turbine portion, and LP turbine portion; and
a steam valve fluidically connected to at least one of the HP turbine portion, IP turbine portion, and LP turbine portion, the steam valve comprising:
a valve body including an inlet portion fluidically connected to the one of the HRSG the boiler and an outlet portion fluidically connected to the one of the HP turbine portion, IP turbine portion, and LP turbine portion, and an interior portion, the interior portion including an inner wall;
a valve member moveably disposed within the interior portion of the valve body, the valve member including an outer surface that is spaced from the inner wall by a gap; and
a floating seal mounted to the inner wall, the floating seal spanning the gap and contacting the outer surface of the valve member.

19. The steam turbomachine system according to claim 18, further comprising: a first seal support mounted to the inner wall and a second seal support mounted to the inner wall spaced from the first seal support, the floating seal being arranged between the first and second seal supports, wherein each of the first and second seal supports extend into, and are constrained by, the inner wall.

20. The steam turbomachine system according to claim 18, wherein the floating seal comprises a plurality of seal members formed from a nickel-chromium based superalloy, the valve member is formed from a nickel-chromium based superalloy, and wherein the inner wall defines a balance chamber formed from a high alloy stainless steel including a chromium content of between about 10% and 16%.
